(19) United States
(12) Patent Application Publication
(10) Pub. No.: US 2010/0037176 A1
(43) Pub. Date: Feb. 11, 2010

(54) APPARATUS FOR SELECTING A GOODS ITEM FROM A SET OF GOODS

(75) Inventors: Werner Engeln, Dettenhausen (DE); Stefan Amrusch, Winterlingen (DE); Gerd Griesohn, Albstadt (DE)

Correspondence Address: Schwabe Williamson & Wyatt;PACWEST CENTER, SUITE 1900, 1211 SW FIFTH AVENUE, PORTLAND, OR, 97204, US

(73) Assignee: METTLER-TOLEDO (ALBSTADT) GMBH, Albstadt (DE)

(21) Appl. No.: 12/298,907

(22) PCT Filed: Feb. 8, 2007
(86) PCT No.: PCT/EP2007/001093

§ 371 Date: Jul. 22, 2009

(30) Foreign Application Priority Data
Apr. 28, 2006 (DE) 10 2006 019 929.4

(51) Int. Cl. G06F 3/048; G06F 17/00; G06F 3/041

(52) U.S. Cl. 715/810; 235/375; 345/173

(57) ABSTRACT

An apparatus for selecting a goods item from a set of goods (5 to 14) which are provided at various locations is provided with a touchscreen (1) which can be used to display a piece of information identifying each goods item and a piece of information identifying the location (15) at which the goods item is provided. A goods item is selected by touching the relevant screen area.

The invention relates to an apparatus for selecting a goods item from a set of goods which are provided at various locations, having a screen which is used to display a piece of information identifying each goods item, for at least one subset containing the goods item to be selected, and the selection being executed by marking the displayed identification information for the goods item.

Apparatuses of this kind are designed specifically for the self-service sale of merchandise to be weighed, for example fruits and vegetables, in supermarkets. In order to transact the purchase process, the customer him- or herself has to remove the goods item from its display shelf and place it on a scale to determine its weight. The screen, typically placed in the vicinity of the scale, displays information identifying each individual goods item for a set of goods items, for example in the form of a symbolic representation or an image of the goods item in a grid arrangement.

In this display, the customer has to recognize the goods item selected by him or her and has to select the respective merchandise identification information, for example by touching the respective grid field on the screen. In doing so, he or she generates the required input information for an evaluation unit which performs a price calculation based on the merchandise identification information and the weight information determined by means of the scale and which activates a printer to output a printed label bearing the weight and the price of the selected goods item.

It is important that these processes be executed as fast as possible and free of errors so as to enable the customer to quickly and reliably recognize the merchandise he or she selected on the screen. This, however, is all the more difficult, the more extensive the amount of goods offered is and/or the greater the similarities in the appearance of the goods items are when the merchandise is glanced at cursorily.

The invention is based on the problem of further developing an apparatus of the type mentioned in the introduction so as to ensure that the goods items are selectable as quickly and reliably as possible.

In accordance with the invention, this problem is solved by enabling the display, on the screen, of a piece of information associated with the merchandise identification information and identifying the location at which the goods item is provided.

Based on the display, in accordance with the invention, of the piece of information identifying the location at which the goods item is provided, in conjunction with the piece of information identifying the goods item, the customer has available a more comprehensive information content which facilitates the customer's recognition of the selected merchandise on the screen and hence the marking of the merchandise on the screen. This increased redundancy makes it possible to transact the sales processes faster and in a more fail-safe manner.

A preferred embodiment of the invention is characterized in that the piece of information identifying the location at which the goods item is provided contains a piece of visual information depicting the location at which the goods item is provided. This form of information identifying the location at which the goods item is provided is particularly advantageous because the customer, who, shortly before, removed the goods item from the place at which it is provided, still has the visual image of the place at which it is provided vividly present in his or her mind's eye, allowing him or her to recognize the respective visual information on the screen in a fast and reliable manner.

In an advantageous alternative in this context, the piece of visual information depicting the location at which the goods item is provided contains a piece of information representing a visual image of the location at which the goods item is provided. This visual image may be generated, for example, electronically, including, in particular, in real time, using an electronic camera, a video camera or a web camera and it may be transmitted to the apparatus wirelessly or through wired communication.

In a different advantageous alternative, the piece of visual information depicting the location at which the goods item is provided contains a piece of information representing a virtual reality model of the location at which the merchandise is provided. The virtual reality model allows a particularly obvious representation of the visual depiction, independent of the customer's reality, which is apt to further facilitate his or her recognition of the respective representation on the screen.

The apparatus in accordance with the invention may be designed such that the merchandise identification information is contained in the visual information. This is the case, for example, when the screen displays a lifelike image of the respective goods item at the location at which it is provided. In this case, the image component of this display depicting the goods item corresponds to the merchandise identification information, while the rest of the visual information displayed represents the information identifying the location at which the goods item is provided. This type of visual information may be supplied in real time, specifically by a video camera or web camera aimed at the goods item and the location at which the goods item is provided.

In the alternative, it may also be advantageous if the visual information includes a piece of information depicting a background image of the location at which the goods item is provided, with merchandise identification information being overlaid onto said background image. In particular, the piece of information depicting the background image of the location at which the goods item is provided may be stationary, while the overlaid merchandise identification information may change dynamically. An example of such a stationary background image is the visual image of an unalterably fixed display shelf. The overlaid merchandise identification information may be the visual image of the respective goods item offered, with the image changing dynamically depending on the merchandise the shelf is currently stocked with.

Furthermore, it is provided within the framework of the invention that the merchandise identification information is capable of being generated by a sensor device capturing the goods items at the location at which they are provided. The sensor device may be equipped, for example, with a visual image recognition device which recognizes the goods item itself or its packaging and uses this information to generate the merchandise identification information. In the alternative, the goods items or their packages may be assigned RFID tags which are capable of being queried by the sensor devices, thereby delivering the merchandise identification information.

With respect to the use of the apparatus for goods items to be weighed and the determination of their price, it is advantageously provided that the screen is arranged at a scale.

Furthermore, it is particularly advantageous for the operation of the apparatus if the screen is a touch screen, enabling the marking of the merchandise by selective touching. This is more suited to accommodate the handling of the sales processes, transacted in a hurry most of the time, than the selection of screen fields by positioning a mouse pointer, followed by clicking, which is widely known from personal computers.

Since the display area available on the screen is limited, it will often not be possible to simultaneously display the identifying information for all goods from which the customer can choose. Instead, this will be possible only for a subset of the total set of goods items. For this reason, an advantageous embodiment involves a screen exhibiting a navigation function, the operation of which makes it possible to select, for display, different locations at which the goods items are provided. In this scenario, it is possible, for example, for arrows to be displayed on the screen which indicate the direction in which the display moves to other locations at which goods items are provided, as soon as the customer touches these arrows or presses the respective arrow keys on a manual input device. In this way, the customer can virtually navigate through the entire sales room in which the points at which the goods are provided are located.

For the identifying recognition of the merchandise, it may be advantageous to initially display the location at which the goods are provided in the largest scale possible on the screen. But this has the disadvantage that the screen areas associated with the individual goods items end up being very small and hence are more difficult to mark. For this reason, an embodiment that is advantageous in this respect involves a screen having a zoom function whose actuation enables the selection of sections of the information shown for an enlarged display on the screen. The actuation of the zoom function may be effected, for example, by the image section to be enlarged being touched and, in response to this action, being enlarged to such a degree that the simple selection and marking is made possible.

And finally, it is also within the scope of the invention that the screen is a 3D screen. The spatial impression conveyed by the 3D screen is especially suited to depict the locations at which the goods items are provided in a particularly life-like manner for the customers and to convey the impression to the customers that they are marking the goods item directly at the actual location at which the goods item is provided and from which they removed the goods item.

In the following, an embodiment of the invention is explained in more detail with reference to the drawing. In the drawing

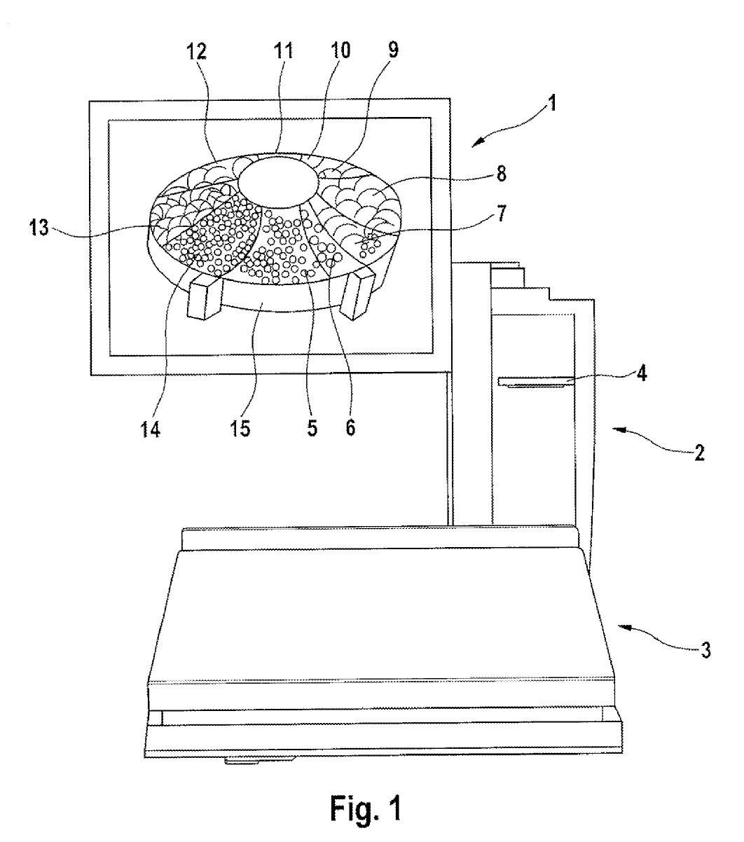

FIG. 1 is a schematic view of an embodiment of an apparatus in accordance with the invention, and

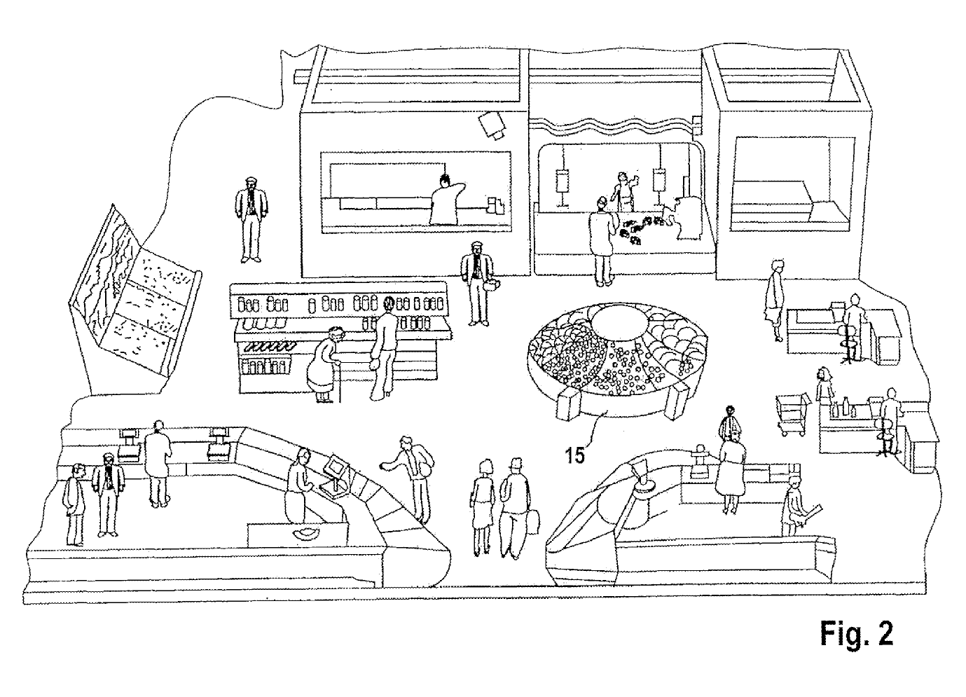

FIG. 2 is a schematic view of a sales room in which the apparatus is used.

The embodiment shown in FIG. 1 exhibits a touch screen 1 which is fixed to an upper portion of a column-like housing 2 which is attached, in its lower portion, to a supporting body of an electronic scale 3. A printer for merchandise labels is provided in the column-like housing 2, with said labels being capable of being removed at an output opening 4. The weight and the price, calculated by the electronic scale 3, of the goods item weighed on the scale 3 is printed on these labels.

In FIG. 1, the touch screen 1 shows a piece of visual information depicting a display shelf 15, stocked with various goods items 5, 6, 7, 8, 9, 10, 11, 12, 13 and 14, and a portion of its surroundings at a store. FIG. 2 shows this display shelf 15 within the entire store.

The visual information displayed on the touch screen 1 in FIG. 1 may be generated, for example, by an electronic camera, a web camera or a video camera focused on the display shelf 15 and transmitted to the touch screen 1 in real time. In this case, a portion of the visual signal depicts a visual image of the goods items 5 to 15, and the rest of this visual signal depicts a visual image of the location at which the goods items are provided, in the form of the display shelf 15 and its immediate surroundings. Hence, this rest of the visual signal constitutes a piece of information identifying the location at which the goods items 5 to 14 are provided, while the former portion is composed of pieces of information identifying the individual goods items 5 to 14.

It should be pointed out that the visual signal can alternatively be generated in any other way that enables the display, on the touch screen 1, of both a piece of information identifying the location at which the goods item is provided, and a piece of information identifying each goods item. For example, a background image of the display shelf 15 in its empty state could be used as information identifying the location at which the goods item is provided, and information identifying the goods items could be overlaid such that the overall impression of a filled shelf is created. These overlays could be individual visual images of the goods items or symbolic representations of the goods items. In their stead, both the visual information depicting the location at which the goods item is provided and the visual information depicting the goods can be generated as virtual reality models.

Furthermore, the shelf 15 could be equipped with sensors identifying the goods items and their position on shelf 15, thus automatically controlling the overlay of the information identifying the goods items on the information identifying the location at which the goods items are provided. For example, the display box of the goods may be equipped with a radio frequency identification transponder tag (RFID) and the sensor device provided on the shelf 15 may be designed such that it recognizes the merchandise, the package size and the position in the shelf 15 as soon as the box is deposited in the shelf 15. Using this information, the control software mounts the given visual representation of the merchandise in the correct place before the background image of the empty shelf 15. When the display box is later removed, the respective area on the touch screen 1 is automatically cleared again.

Using the apparatus explained with reference to FIGS. 1 and 2 by way of example, self-service sales processes can be transacted in the following manner: The customer removes one of the goods items 5 to 14 from the display shelf 15 and puts it on the scale 3. The customer also marks the respective goods item on the touch screen 1 by touching the area depicting the respective goods item. Using the merchandise identification number selected in this way and the merchandise weight captured by the electronic scale 3, the latter calculates the sales price and triggers the printer such that a merchandise label bearing the weight and the sales price is printed out. The customer removes this merchandise label at the output opening 4 and sticks it on the selected merchandise. In this way, the merchandise is prepared for the billing process at the cash register of the store.

In order to make this selection possible in an uncomplicated way by the touching of the touch screen, the individual screen areas depicting the individual goods items 5 to 14 may not be too small since only one of these areas may be touched at one time and no touching of overlapping areas may occur. For this purpose, a zoom function is preferably provided which initially effects the magnification of the information displayed in the area of the respective spot that was touched, until the screen areas corresponding to the respective goods items are large enough to enable a simple and reliable selection.

Furthermore, the device may be equipped with a navigation function enabling the customer to virtually navigate from one location to another location at which the goods are provided in the store. For this purpose, it is possible for an arrow to appear on the left and right in the respective current display of the location at which the goods item is displayed—in FIG. 1, the display shelf 15 and its immediate surroundings—with the screen 1, upon touching, being moved forward to show the respective next closest display shelf.

### LIST OF REFERENCE NUMBERS

1 touch screen
2 column-like housing
3 electronic scale
4 outlet opening
5 goods item
6 goods item
7 goods item
8 goods item
9 goods item
10 goods item
11 goods item
12 goods item
13 goods item
14 goods item
15 display shelf

Text on bottom of FIG. 1 page=Substitution page (Regulation 26)

Text on bottom of FIG. 2 page=Substitution page (Regulation 26)

1. Apparatus for selecting a goods item from a set of goods which are provided at various locations, having a screen which is used to display a piece of information identifying each goods item, for at least one subset containing the goods item to be selected, and the selection being executed by marking the displayed identification information for the goods item, characterized in that a piece of information associated with the merchandise identification information and identifying the location at which the goods item is provided, can be displayed on the screen.

2. Apparatus in accordance with claim 1, characterized in that the information identifying the location at which the goods item is provided contains a piece of visual information depicting the location at which the goods item is provided.

3. Apparatus in accordance with claim 2, characterized in that the visual information depicting the location at which the goods item is provided contains a piece of information representing a visual image of the place at which the goods item is provided.

4. Apparatus in accordance with claim 2, characterized in that the visual information depicting the location at which the goods item is provided contains a piece of information representing a virtual reality model of the place at which the goods item is provided.

5. Apparatus in accordance with claim 2, characterized in that the merchandise identification information is contained in the visual information.

6. Apparatus in accordance with claim 2, characterized in that the visual information contains a piece of information depicting a background image of the location at which the goods item is provided, which is overlaid with the merchandise identification information.

7. Apparatus in accordance with any of the claim 1, characterized in that the merchandise identification information is capable of being generated by a sensor device capturing the goods items at the locations at which the goods items are provided.

8. Apparatus in accordance with claim 7, characterized in that the sensor device exhibits a information retrieval device for RFID tags associated with the goods items.

9. Apparatus in accordance with claim 7, characterized in that the sensor device exhibits an electronic camera serving to capture images.

10. Apparatus in accordance with claim 1, characterized in that the locations at which the goods items are provided are located in a store.

11. Apparatus in accordance with claim 10, characterized in that the locations at which the goods items are provided are located on display shelves.

12. Apparatus in accordance with claim 1, characterized in that the merchandise identification information contains a piece of visual information depicting the goods items.

13. Apparatus in accordance with claim 12, characterized in that the information depicting the goods item represents a symbol corresponding to the goods items.

14. Apparatus in accordance with claim 1, characterized in that the screen is arranged on a scale.

15. Apparatus in accordance with claim 1, characterized in that screen is a touch screen used to enable the marking by selective touching.

16. Apparatus in accordance with claim 1, characterized in that the screen is a 3D screen.

17. Apparatus in accordance with claim 1, characterized in that the screens exhibits a navigation function, which is used to select, for display, different locations at which the goods items are provided.

18. Apparatus in accordance with claim 1, characterized in that the screen exhibits a zoom function, which is used to select sections of the displayed information for enlarged display on the screens.
